(19) United States
(12) Patent Application Publication
(10) Pub. No.: US 2018/0165408 A1
(43) Pub. Date: Jun. 14, 2018

(54) FINITE ELEMENT SIMULATION DEVICE AND METHOD FOR CAR BODY LOCAL STRUCTURE INSTABILITY OF HIGH-SPEED MOTOR TRAIN UNIT

(71) Applicant: CRRC QINGDAO SIFANG CO., LTD., Qingdao, Shandong (CN)

(72) Inventors: Yunshuang MA, Qingdao, Shandong (CN); Hongwei ZHAO, Qingdao, Shandong (CN); Aiqin TIAN, Qingdao, Shandong (CN); Sansan DING, Qingdao, Shandong (CN)

(73) Assignee: CRRC QINGDAO SIFANG CO., LTD., Qingdao, Shandong (CN)

(21) Appl. No.: 15/106,276

(22) PCT Filed: Nov. 10, 2015
(86) PCT No.: PCT/CN2015/094174

§ 371 Date: Jun. 17, 2016

(30) Foreign Application Priority Data
Mar. 12, 2015 (CN) 201510108956.8

(51) Int. Cl. G06F 17/50

(52) U.S. Cl. CPC G06F 17/5095; G06F 17/5086; G06F 2217/06; G06F 2217/02; G06F 17/5036

(57) ABSTRACT

A finite element simulation device and a method for car body local structure instability of a high-speed motor train unit are provided. A human-machine interaction device is adopted to model firstly according to car body drawings and to build and simulate a dent portion in a local part of the car body. A boundary constraint of the car body is established, a maximum vertical load and a compression load of the car body are linearly composited, a modal frequency of the car body is defined, a static load working condition and a linear buckling analysis working condition are established, and then a car body instability simulation analysis is performed to calculate a critical buckling coefficient, thus the maximum load allowed to be applied is obtained.

This application claims the benefit of priority to Chinese patent application No. 201510108956.8, titled “FINITE ELEMENT SIMULATION DEVICE AND METHOD FOR CAR BODY LOCAL STRUCTURE INSTABILITY OF HIGH-SPEED MOTOR TRAIN UNIT”, filed with the Chinese State Intellectual Property Office on Mar. 12, 2015, the entire disclosure of which is incorporated herein by reference.

### TECHNICAL FIELD

This application relates to the field of high-speed motor train units, specifically relates to design of a car body structure, and particularly relates to structure instability analysis in assessing safety of the car body after a dent occurs to the car body.

### BACKGROUND

Simulating and analyzing of a car body structure of a motor train unit is mainly simulating and analyzing the strength and the rigidity of the car body structure referring to related strength standards, such as Japanese Standard JIS E7105:2006, European Standard EN12663:2010 and Interim Provision on 200 Kilometer Strength. The safety of the car body after a dent occurs to the car body cannot be assessed through these calculated load working conditions. Therefore, structure instability analysis should be performed to assess the safety of the car body.

### SUMMARY

A finite element simulation device and a method for car body local structure instability of a motor train unit are provided. By adopting the finite element simulation method, a perfect state of the car body structure and a defect state, such as a dent and a convex, of a local profile are simulated, and a critical loading force local structure instability of the motor train unit is analyzed. Thus, tool applying, adjustment and repair technology, and setting of welding parameters in the field processing and manufacturing process are guided. By adopting the simulation analysis method for the car body structure instability, defect states, such as, a dent portion or a convex portion generated to the car body in the processing and manufacturing process, may be evaluated properly relatively, thereby guiding the manufacturing and processing of the car body and avoiding excessive material wastes in the process of manufacturing the car body.

The technical solution of the present application is described as follows:

A finite element simulation device for car body local structure instability of a high-speed motor train unit, including three parts: a first part being a module for building finite element model of a car body structure, a second part being a module for building boundary condition of the car body structure, and a third part being a car body structure instability simulation analysis module, wherein each of the first part and the second part is connected to the third part, wherein:
in the first part module, designed shape and dimensions of the car body are obtained by a human-machine interaction device and modeling is performed, and the first part module further includes a module for building a local dent area model, which is configured to build and simulate at least one dent portion at a local part of the car body;
the second part module includes: a module for building boundary constraint of the car body, a module for defining a maximum vertical load and a compression load of the car body, a module for obtaining a composite load by linearly compositing, a module for defining a modal frequency of the car body, a module for defining a static load working condition, and a module for defining a linear buckling analysis working condition, which are configured by the human-machine interaction device, wherein:
   the module for building a boundary constraint of the car body is configured to constrain and limit a degree of freedom of at least one position selected from the car body;
   the module for defining a maximum vertical load and a compression load of the car body is configured to apply an uniformly distributed load, which is the maximum vertical load that the car body can bear, on a horizontal plane of the car body, and apply a longitudinal compression load on at least one position of the car body;
   the module for obtaining a composite load by linearly compositing is configured to receive data from the module for defining the maximum vertical load and the compression load of the car body, and linearly composite the maximum vertical load and the compression load;
   the module for defining a modal frequency of the car body is configured to set range values of the modal frequency of the car body as the standby, and provide the range values of the modal frequency of the car body to the third part module;
   the module for defining a static load working condition is configured to set a static load of the car body as the standby; and
   the module for defining a linear buckling analysis working condition is configured to connect the module for defining static load working condition and the module for defining a modal frequency of the car body to obtain data of the static load and the modal frequency; and
the third part module is configured to perform a car body structure instability simulation analysis after obtaining the data of the first part module and the second part module, and the third part module includes a module for calculating critical buckling coefficient, a module for extracting critical instability loading force, and a module for comparing and analyzing a car body structural strength loading force and a critical instability loading force, which are connected in sequence, wherein:
   the module for calculating critical buckling coefficient is configured to output the critical buckling coefficient of the dent portion to the module for extracting critical instability loading force;
   the module for extracting critical instability loading force is configured to obtain the maximum load allowed to be exerted on the structure at the dent portion, i.e., obtain a critical instability loading force in the case that the local structure of the car body loses stability, and output the critical instability loading force as the standby; and
   the module for comparing and analyzing a car body structural strength loading force and a critical instability loading force is configured to obtain a critical instability loading force in the case that the a local part of the car body loses stability, extract the loading force of the local part after a car body structural strength analysis, and compare the critical instability loading force with the loading force of the local part, if the loading force obtained according to the car body structural strength is less than the critical instability loading force, the car body structure in this defect state is reliable during operating process, and if the loading force obtained according to the car body structural strength is greater than the critical instability loading force, a further reinforcing solution needs to be made to the car body structure having such defect to improve the rigidness of a defect part.

Further, the first part module includes a module for setting material parameter of the car body, a module for setting plate thickness parameter of parts of the car body, a module for building a whole car body finite element model, and a module for building a local dent area model, wherein
the module for setting material parameter of the car body is configured to obtain parameters of material adopted by the car body;
the module for setting plate thickness parameter of parts of the car body is configured to obtain attribute assignments of the plate thickness parameters of the parts of car body according to car body design drawing data;
the module for building a whole car body finite element model is configured to build a car body finite element model according to the car body structure shown in the drawings, wherein the car body structure is simulated by using a quadrilateral plate element, a local part is simulated by using a triangular plate element, and a two-dimensional model of the car body structure is obtained; and
the module for building a local dent area model is configured to build a dent model of the local part in the whole car body finite element model and set dimensions of a dent portion.

Further, the third part module further includes a module for determining that the local part of the car body structure is reliable, a module for determining that the local part is required to be reinforced, and a module for comparing and analyzing a car body structural strength loading force and a critical instability loading force, and
according to a data analysis result, if the critical buckling coefficient is greater than or equal to 1, the module for comparing and analyzing is connected to the module for determining that the local part of the car body structure is reliable, and if the critical buckling coefficient is less than 1, the module for comparing and analyzing is connected to the module for determining that the local part is required to be reinforced.

Further, in the module for building a boundary constraint of the car body, translational degrees of freedom in three directions are constrained at four air springs of the car body.

Further, the compression load is set to be a car body longitudinal load exerted on a coupler mounting seat; and the maximum vertical load is set to be an uniformly-distributed load exerted on a car body floor.

Further, the maximum vertical load is 547.6 kN, i.e., the uniformly-distributed load exerted on the car body floor is 547.6 kN; the compression load is 1500 kN, i.e., the car body longitudinal load exerted on the coupler mounting seat is 1500 kN.

Further, in the module for building a whole car body finite element model, the plate element has a size set to be 20 mm; and in the module for defining a modal frequency of the car body, the modal frequency is defined to range from 1 HZ to 40 HZ.

Further, in the module for building a local dent area model, the dent portion has a dent depth of 4 mm and a dent length of 3800 mm.

A car body local structure instability finite element simulation method for high-speed motor train units is provided, which includes following steps:
a first step, including performing modeling to designed shape and dimensions of the car body by a human-machine interaction device, and building a local dent model of the car body, to build and simulate at least one dent portion at a local part of the car body;
a second step, configuring boundary conditions of the car body structure by the human-machine interaction device, wherein including steps in the following sequence:
   S1, building a boundary constraint of the car body, including constraining and limiting a degree of freedom of at least one position selected from the car body;
   S2, defining a maximum vertical load and a compression load of the car body, including: applying an uniformly-distributed load, which is the maximum vertical load exerted on the car body, on a horizontal plane of the car body, and applying a longitudinal compression load on at least one position of the car body;
   S3, obtaining a composite load by linearly compositing, including linearly compositing the maximum vertical load and the compression load after data of the maximum vertical load and the compression load of the car body are set;
   S4, defining a modal frequency of the car body, including setting range values of modal frequency of the car body as the standby;
   S5, defining a static load working condition, including setting a static load of the car body as the standby; and
   S6, defining a linear buckling analysis working condition module, including configuring the static load and modal frequency data that are set; and
a third step, including:
   performing a car body structural instability simulation analysis, obtaining a critical buckling coefficient 0.X of the dent portion by calculating, and confirming that an instability phenomenon occurs to the structure when the load reaches X % of the initially applied load according to results, and further obtaining a maximum load allowed to be exerted on the structure;
   determining that the local part of the car body structure is reliable if the critical buckling coefficient is greater than or equal to 1; and
   determining that the local part needs to be reinforced if the critical buckling coefficient is less than 1.

A finite element simulation method for car body local structure instability of a high-speed motor train unit is provided, which includes following steps:
Step 1, inputting material parameters of a car body;
Step 2, performing an attribute assignment to plate thickness of parts of car body according to car body design drawing data;
Step 3, building a car body finite element model according to the car body structure in drawings, wherein a car body structure is simulated by using a quadrilateral plate element and a local part is simulated by using a triangular plate element, to obtain a two-dimensional model of the car body;
Step 4, building a dent model of a local area in the whole car body finite element model, including setting a dent depth and a dent length of the dent area;
Step 5, configuring and building a boundary constraint condition of the car body, i.e. constraining translational degrees of freedom, at positions of four air springs, of the car body in three directions, and keeping the configuration in an activated state in subsequent constraint processes of the car body;
Step 6, setting a maximum vertical load and a compression load, and keeping respective cards in an activated state in subsequent load application process of the car body, and applying a compression load in a longitudinal direction of the car body on a coupler mounting seat, and applying a uniformly-distributed load on the car body floor;
Step 7, performing calculation on complex working conditions, including linearly compositing the two loads, i.e., the maximum vertical load and the compression load, to check the car body linear buckling under complex working conditions;
Step 8, defining a card of modal frequency of the car body, wherein a frequency range of the modal frequency is set to be from 1 HZ to 40 HZ.
Step 9, defining a static load working condition, including selecting the above boundary constraint condition and the composite load;
Step 10, defining a linear buckling analysis working condition, including selecting the static load working condition and the modal frequency of the car body which are defined above;
Step 11, calculating a critical buckling coefficient, including performing a car body structure instability simulation analysis to obtain the critical buckling coefficient 0.X of the dent portion by calculating;
Step 12, determining a maximum load allowed to be exerted on the structure if the result indicates that an instability phenomenon occurs to the structure when the load reaches X % of the initially applied load;
Step 13, comparing and analyzing the critical instability loading force when a dent portion occurs in the local part of the car body structure obtained in the above step and the loading force of the portion extracted after analyzing the strength of the car body structure;
Step 14, determining that the car body structure in the defect state is reliable in operating if the loading force obtained according to the strength of the car body structure is less than or equal to the critical instability loading force; and
Step 15, determining that further reinforcing solution needs to be made to the car body structure having the defect to improve the rigidness of the defect portion if the loading force obtained according to the strength of the car body structure is greater than the critical instability loading force.

### BRIEF DESCRIPTION OF THE DRAWINGS

FIG. 1 is a view showing the structure of a finite element simulation device for a car body local structure instability of a high-speed motor train unit according to the present application;

FIG. 2 is a schematic flowchart showing the finite element simulation device for a car body local structure instability of a high-speed motor train according to the present application;

FIG. 3 is a setting interface of material parameters when the present application is implemented in Hyperworks software;

FIG. 4 is a setting interface of plate thickness when the present application is implemented in Hyperworks software;

FIG. 5 is a view of two-dimensional model of the car body when the present application is implemented in Hyperworks software;

FIG. 6 is a view of a dent model in a local area of the car body when the present application is implemented in Hyperworks software;

FIG. 7 is an interface for defining constraint parameters when the present application is implemented in Hyperworks software;

FIG. 8 is a schematic view showing positions on car body where constraints are defined according to the present application;

FIG. 9 is an interface for defining a load and a modal frequency when the present application is implemented in Hyperworks software;

FIG. 10 is an interface for defining a static load working condition when the present application is implemented in Hyperworks software;

FIG. 11 is an interface for defining working condition of a linear buckling analysis when the present application is implemented in Hyperworks software; and

FIG. 12 is a perspective view of an analysis model for simulating and analyzing of instability of car body according to the present application.

In the drawings, 1 indicates a dent portion, and 2 indicates an air spring.

### DETAILED DESCRIPTION

The present application is now further illustrated in conjunction with the drawings and embodiments.

In this embodiment, the conventional Hyperworks software is adopted by a finite element simulation device and method for car body local structure instability of a motor train unit as a human-machine interaction basis to form this solution. However, the device and the method may also be implemented in other similar finite element analysis softwares.

1. Establishing a Finite Element Model of Car Body Structure in the Hypermesh Module of the Hyperworks Software.

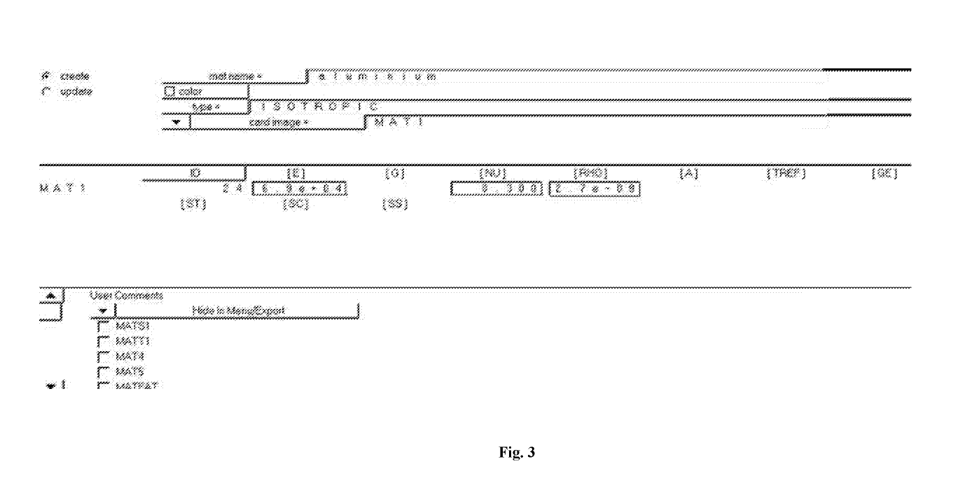

1.1 Setting Material Parameters
the car body structure is made of aluminium alloy material, accordingly the material parameters are as follows: E is 69000 Mpa, μ is 0.3, and p is 2.7e-9t/mm³; and
the material parameters are set in the material definition module, as shown in FIG. 3.

1.2 Setting Element Attributes

Assigning values to the plate thickness attribute of the structures of various parts of the car body according to design drawings of the car body. Since a car body structure involves a large number of plate thickness attribute assignments, only one of the plate thickness attributes is illustrated herein, as shown in FIG. 4. Other plate thickness attribute assignments are not described herein.

1.3 Establishing Finite Element Model of the Car Body

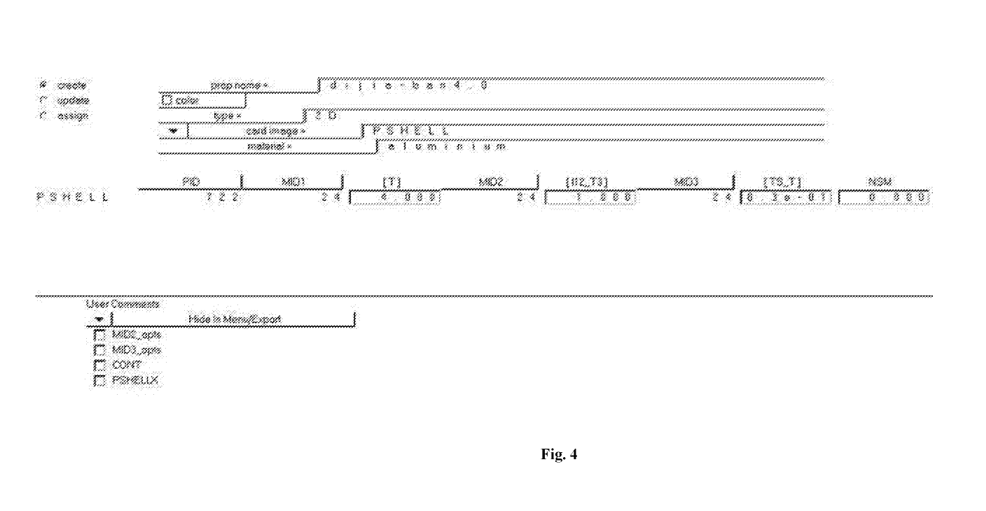

Establishing a finite element model of the car body according to the car body structure in the design drawings. The vehicle body structure is simulated mainly by quadrangular shaped plate elements, and a local structure is simulated by triangular shaped plate elements. The size of a plate element is set to be 20 mm. Thus a two-dimensional model of the car body shown in FIG. 5 is obtained.

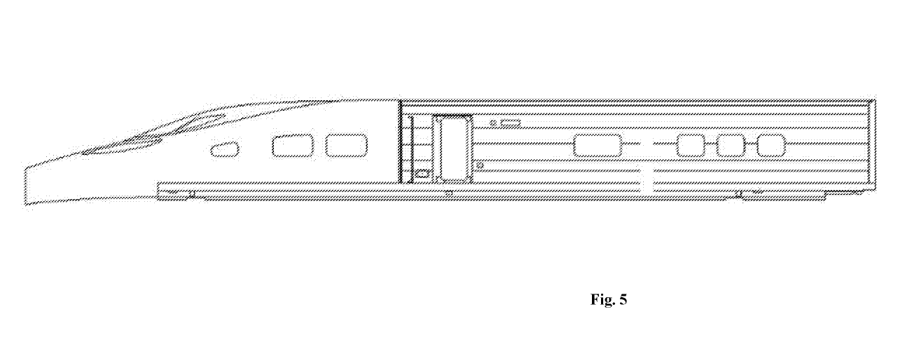

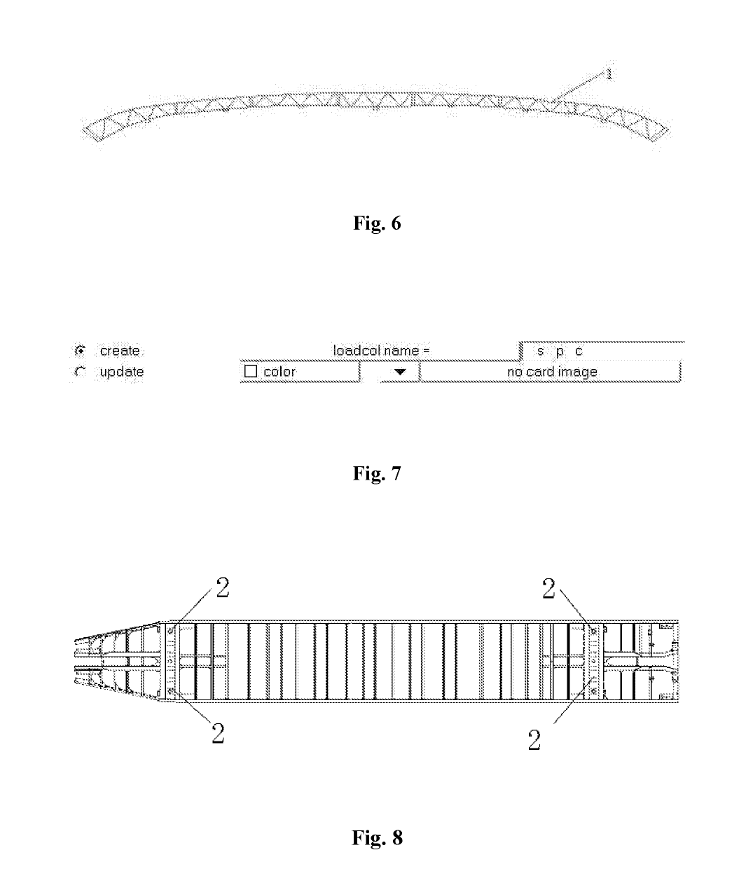

A model of a dent in the local area is established in the finite element model of the entire car body. The size of a dent area is assumed to be that: a depth of the dent is 4 mm and a length of the dent is 3800 mm. A specific section position is shown in FIG. 6.

2. Establishing Boundary Conditions of the Car Body Structure.

2.1 Setting Up Constraints

Definition card “spc” of constraints is established in the hypermesh module. This card is kept in an activated state in the subsequent constraining of the car body, as shown in FIG. 7.

As shown in FIG. 8, four air springs are provided at the car body to constrain translational degrees of freedom in three directions.

2.2 Establishing Loads

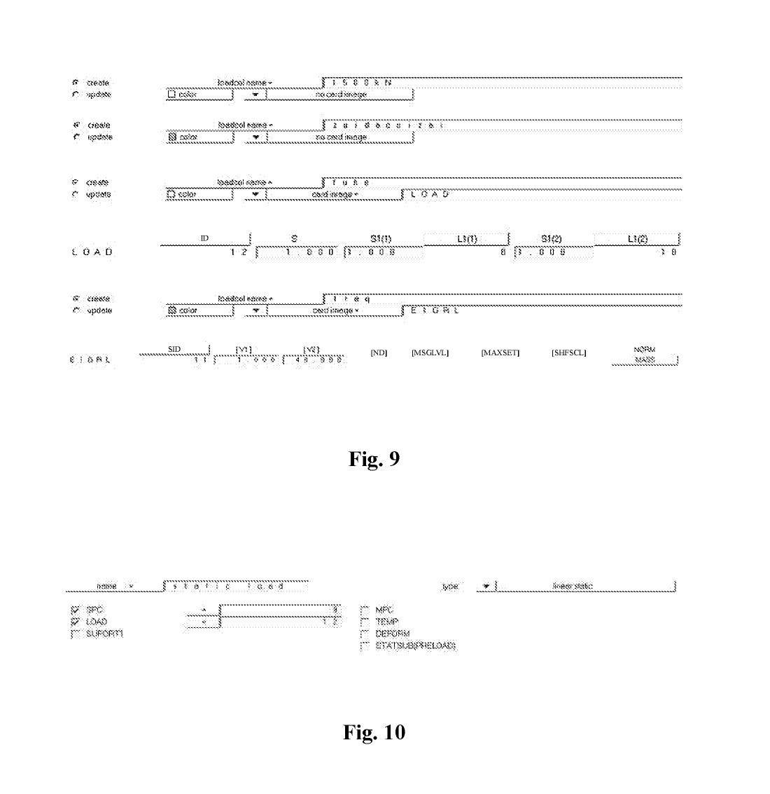

As shown in FIG. 9, definition cards for loads of 1500 kN, “zuidacuizai” and a composited load are established in the hypermesh module. Corresponding cards are kept in an activated state when the loads are applied to the car body subsequently.

In this conducted analysis, linear buckling of the car body under a complex working condition, that is a maximum vertical load (547.6 kN) and compressive load (1500 kN), is mainly assessed. The load of 1500 kN in the longitudinal direction of car body is applied to a coupler mounting base, and the uniformly-distributed load of 547.6 kN is applied on a floor plane of the car body.

The definition of the complex working condition can be known from a definition method for the card “fuhe” shown in FIG. 9, in which two loads, i.e., a maximum vertical load and a compressive load, are linearly composited.

Meanwhile a card for modal frequency of the car body is also defined. The name of the card is defined as “freq”, and a frequency range is from 1 HZ to 40 HZ.

2.3 Establishing Load Analysis Working Condition

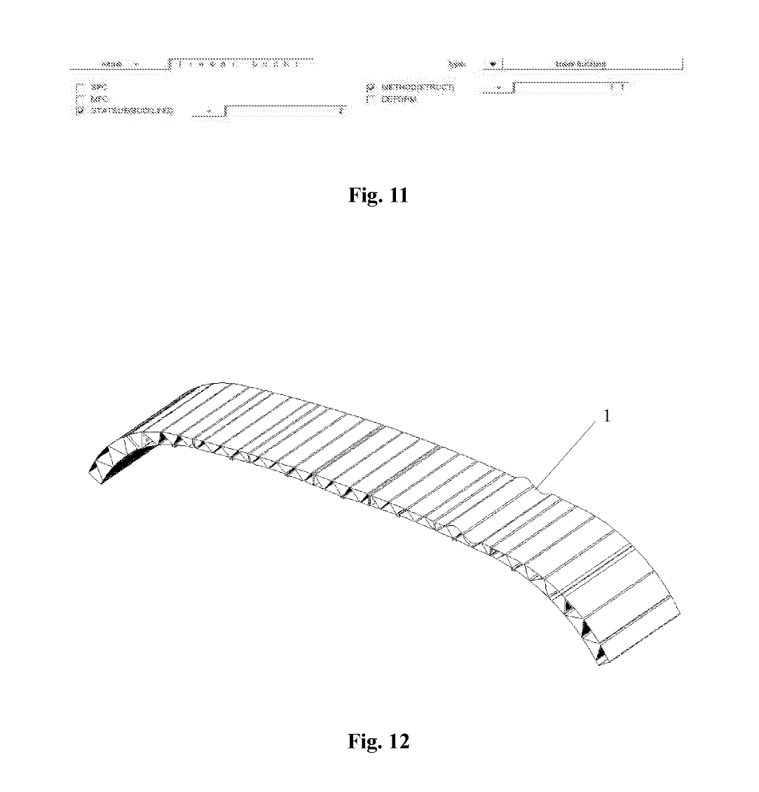

After the finite element model of the car body is established and corresponding constraints and loads are set, the next step is establishing a load analysis working condition. Since this analysis is directed to a linear buckling analysis, corresponding definition in the hypermesh module is shown in FIGS. 10 and 11. Firstly, a static load working condition is defined, the name of this condition is defined as “static load”, the constraint “spc” is selected, and the load “fuhe” is selected.

And then a linear buckling analysis working condition is defined, the name of this condition is defined as “linear buckling”, the static load condition “static load” and the modal frequency “freq” defined above are selected.

3. Calculating Result

As shown in FIG. 12, the instability of car body structure is simulated and analyzed. By calculating, it is known that the critical buckling coefficient of a portion in FIG. 12 is 0.874. The result demonstrates that the structure already loses stability when 87.4 percents of the initial applied load is applied. Thus the maximum load that the structure can be applied is obtained.

4. After the linear buckling analysis, a critical instability loading force corresponding to the case that a dent occurs to the local structure of the car body can be known. A loading force applied to this part is obtained after the structural strength analysis of the car body, the critical instability loading force and the loading force of the local part are compared, if the loading force obtained according to the structural strength of the car body is less than the critical instability loading force, the structure of the car body under this defect state is reliable in operating process; and if the loading force obtained according to the structural strength of the car body is greater than the critical instability loading force, a further reinforcing solution needs to be made to the structure of the car body with the defect, in order to improve the rigidness of the defect part.

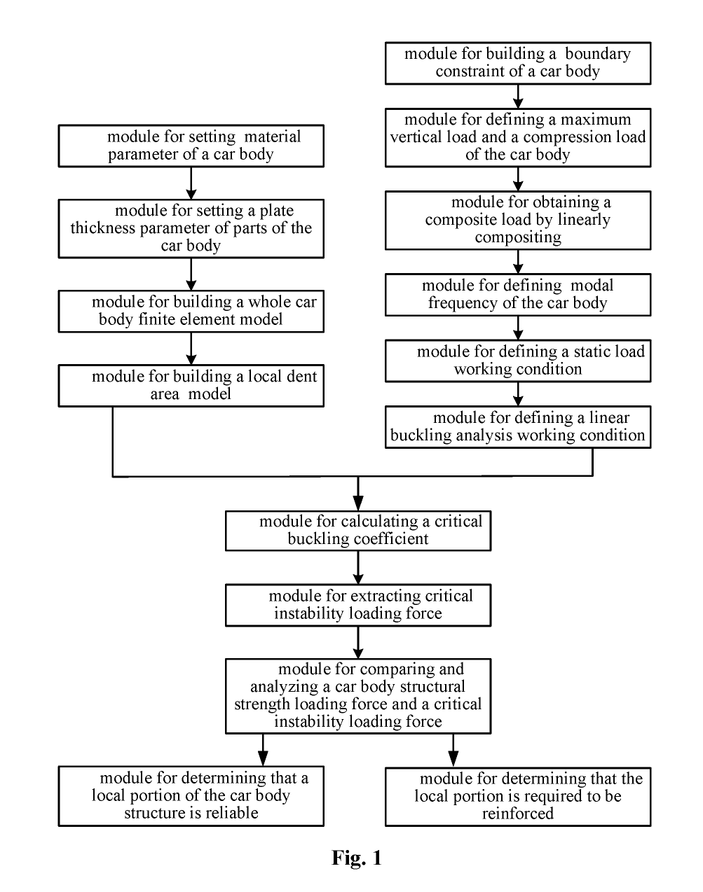

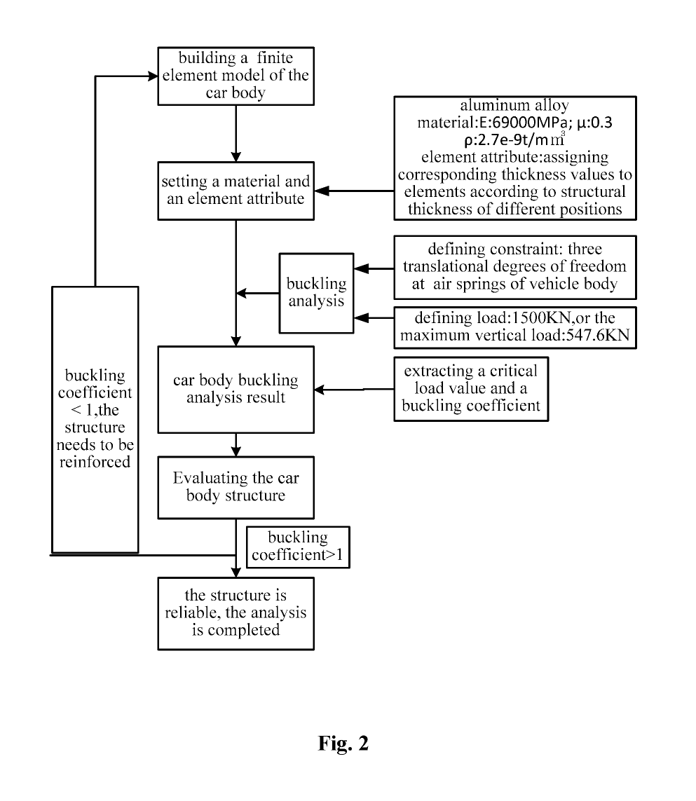

As shown in FIG. 1 and FIG. 2, a finite element simulation device for car body local structure instability of a high-speed motor train unit includes three parts. A first part is a module for building a finite element model of a car body structure, a second part is a module for building a boundary condition of the car body structure, and a third part is a car body structure instability simulation analysis module. Each of the first part and the second part is connected to the third part.

In the first part module, a shape and a size of the car body design is obtained by a human-machine interaction device and then a model is built, a model for building a local dent area model is further included, which is configured to build and simulate at least one dent portion on a local part of the car body;

The second part module includes a module for building a boundary constraint of the car body, a module for defining a maximum vertical load and a compression load of the car body, a module for obtaining a composite load by linearly compositing, a module for defining a modal frequency of the car body, a module for defining a static load working condition, and a module for defining a linear buckling analysis working condition, which are all configured by the human-machine interaction device. The module for building a boundary constraint of the car body is configured to constrain and limit a degree of freedom of at least one position selected from the car body. The module for defining a maximum vertical load and a compression load of the car body is configured to apply a uniformly distributed load on a horizontal plane of the car body, with the uniformly distributed load being the maximum vertical load that the car body bears, and build a longitudinal compression load on at least one position of the car body. The module for obtaining a composite load by linearly compositing is configured to receive data of the module for defining a maximum vertical load and a compression load of the car body, and linearly composite the maximum vertical load and the compression load. The module for defining a modal frequency of the car body is configured to set range values of the modal frequency of the car body as the standby, and provide the range values of the modal frequency of the car body to the third part module. The module for defining a static load working condition is configured to set a static load of the car body as the standby. The module for defining a linear buckling analysis working condition is configured to connect the module for defining a static load working condition and the module for defining a modal frequency of the car body to obtain data of the static load and the modal frequency.

The third part module is configured to perform a car body structure instability simulation analysis after obtaining data of the first part module and the second part module. The third part module includes a module for calculating a critical buckling coefficient, a module for extracting a critical instability loading force, and a module for comparing and analyzing a car body structural strength loading force and the critical instability loading force, which are connected in the listed sequence. The module for calculating a critical buckling coefficient is configured to output a critical buckling coefficient of the dent portion to the module for extracting a critical instability loading force. The module for extracting critical instability loading force is configured to obtain the maximum load that the structure at the dent portion can bear, i.e., obtain a critical instability loading force in the case that the local structure of the car body loses stability, and output the critical instability loading force as the standby. The module for comparing and analyzing a car body structural strength loading force and a critical instability loading force is configured to obtain a critical instability loading force in the case that the local structure of the car body loses stability, extract the loading force applied to the portion through the car body structural strength analysis, and compare the critical instability loading force with the loading force applied to the portion, if the loading force obtained according to the car body structural strength is less than the critical instability loading force, the car body structure under this defect state is reliable during operation, and if the loading force obtained according to the car body structural strength is greater than the critical instability loading force, a further reinforcing solution needs to be made to the car body structure with such defect to improve the rigidness of the portion with defect.

The first part module includes a module for setting material parameters of the car body, a module for setting plate thickness parameter of parts of the car body, a module for building a whole car body finite element model, a module for building a local dent area model. Specifically, the module for setting material parameters of the car body is configured to obtain parameters of the material adopted by the car body. The module for setting plate thickness parameter of parts of the car body is configured to obtain an attribute assignment of the plate thickness parameter of each part of the car body according to drawings and data of the car body design. The module for building a whole car body finite element model is configured to build a finite element model of the car body according to the car body structure shown in the drawings, wherein the car body structure is simulated using a quadrilateral plate element, and local part is simulated using a triangular plate element, and a two-dimensional model of the car body structure is obtained. The module for building a local dent area model is configured to build a dent model of a local dent area in the whole car body finite element model and set a dimension of the dent portion 1.

The third part module further includes a module for determining that the part of the car body structure is reliable, a module for determining that the part is required to be reinforced, and a module for comparing and analyzing a car body structural strength loading force and a critical instability loading force. According to a data analysis result, if the critical buckling coefficient is greater than or equal to 1, the module for comparing and analyzing is connected to the module for determining that the part of the car body structure is reliable; if the critical buckling coefficient is less than 1, the module for comparing and analyzing is connected to the module for determining that the part is required to be reinforced.

In the module for building a boundary constraint of the car body, translational degrees of freedom in three directions are constrained at four air springs 2 of the car body.

Further, the compression load is set to be a car body longitudinal load exerted on a coupler mounting seat. The maximum vertical load is set to be a uniformly-distributed load exerted on a floor of the car body. The maximum vertical load is 547.6 KN, i.e., the uniformly-distributed load exerted on the car body floor is 547.6 KN. The compression load is 1500 kN, i.e., the car body longitudinal load exerted on the coupler mounting seat is 1500 kN. In the module for building a whole car body finite element model, the plate element has a size set to be 20 mm. In the module for defining modal frequency of the car body, the value range of the modal frequency is defined to be from 1 HZ to 40 HZ. In the module for building a local dent area model, the dent portion has a dent depth of 4 mm and a dent length of 3800 mm.

A car body local structure instability finite element simulation method for a high-speed motor train unit is provided, which includes following steps.

In a first step, modeling is performed to designed shape and dimensions of a car body by a human-machine interaction device, a local dent area model of the car body is built, and at least one dent portion at a local area of the car body is modeled and simulated;

In a second step, a boundary condition of the car body structure is configured by the human-machine interaction device, and execution steps include the following steps in order:
S1, building a boundary constraint of the car body, including constraining and limiting a degree of freedom, of at least one portion selected from the car body;
S2, defining a maximum vertical load and a compression load of the car body, including: exerting a uniformly-distributed load on a horizontal plane of the car body, with the uniformly-distributed load being the maximum vertical load exerted on the car body, and exerting a longitudinal compression load on at least one portion of the car body;
S3, obtaining a composite load by linearly compositing, including linearly compositing, the maximum vertical load and the compression load after data of the maximum vertical load and the compression load of the car body are set by the module for defining a maximum vertical load and a compression load;
S4, defining a modal frequency of the car body, including setting a value range of the modal frequency of the car body as the standby;
S5, defining a static load working condition, including setting a static load of the car body as the standby; and
S6, defining a linear buckling analysis working condition module, including configuring the static load and modal frequency data having been set.

In a third step, a structural instability simulation analysis of the car body is performed, a critical buckling coefficient 0.X of the dent portion is obtained by calculating, the result indicates that, an instability phenomenon occurs to the structure when the load reaches X % of the initially applied load, and further a maximum load that the structure can bear is obtained; if the critical buckling coefficient is greater than or equal to 1, it is determined that the portion of the car body structure is reliable; and if the critical buckling coefficient is smaller than 1, it is determined that the portion needs to be reinforced.

A finite element simulation method for car body local structure instability of a high-speed motor train unit is provided, which includes following steps:
Step 1, inputting various material parameters of a car body;
Step 2, performing an attribute assignment to plate thickness of portions of the car body according to car body design drawing data;
Step 3, building a car body finite element model according to the structure of the car body shown in drawings, where a car body structure is simulated by using a quadrilateral plate element and a local area of the car body is simulated by using a triangular plate element, to obtain a two-dimensional model of the car body;
Step 4, building a dent model of the local area in the whole car body finite element model, including setting a dent depth and a dent length of the dent area;
Step 5, configuring and setting a boundary constraint condition of the car body, including constraining translational degrees of freedom in three directions, at positions of four air springs, of the car body; and keeping the configuration in an activated state in subsequent constraint processes of the car body;
Step 6, setting a maximum vertical load and a compression load, and keeping corresponding cards in an activated state in subsequent load applying process of the car body; and applying the compression load in a longitudinal direction of the car body on a coupler mounting seat, and applying the uniformly-distributed load on the car body floor;
Step 7, performing calculation on complex working conditions, including linearly compositing the two loads, i.e., the maximum vertical load and the compression load, to test the linear buckling of the car body under complex working conditions;
Step 8, defining a card of a modal frequency of the car body, where a frequency range of the modal frequency is set to be from 1 HZ to 40 HZ.
Step 9, defining a static load working condition, including selecting the above boundary constraint condition and the composite load;
Step 10, defining a linear buckling analysis working condition, including selecting the static load working condition and the modal frequency of the car body which are defined above;
Step 11, calculating a critical buckling coefficient, including performing a car body structure instability simulation analysis to obtain the critical buckling coefficient 0.X of the dent portion by calculating;
Step 12, determining a maximum load that the structure can bear if the result indicates that an instability phenomenon occurs to the structure when the load reaches X % of the initially applied load;
Step 13, comparing and analyzing the critical instability loading force when a dent portion occurs to the local part of the car body structure obtained in the above step and the loading force of the portion extracted after analyzing the strength of the car body structure;
Step 14, determining that the car body structure in the defect state is reliable in operating if the loading force obtained according to the strength of the car body structure is less than or equal to the critical instability loading force; and
Step 15, determining that further reinforcing solution needs to be made to the car body structure with the defect to improve the rigidness of the defect portion if the loading force obtained according to the car body structural strength is greater than the critical instability loading force.

Finally, it should be noted that, the above embodiments are only intended to illustrate the technical solutions of the present application, and should not be interpreted as a limit to the technical solutions of the present application. Though the present application has been described in detail with reference to the above preferred embodiments, it should be understood by those skilled in the art that, modifications still may be made to the various embodiments of the present application, or equivalent substitutions may be made to a part of the technical features; and all these modifications or substitutions without departing from the spirit of technical solutions of the present application all fall into the protection scope of the technical solutions of the present application.

1. A finite element simulation device for car body local structure instability of a high-speed motor train unit, comprising three parts: a first part being a module for building a finite element model of a car body structure, a second part being a module for building a boundary condition of the car body structure, and a third part being a car body structure instability simulation analysis module, wherein each of the first part and the second part is connected to the third part, wherein:
in the first part module, designed shape and dimensions of the car body are obtained by a human-machine interaction device and modeling is performed, and the first part module further comprises a module for building a local dent area model, which is configured to build and simulate at least one dent portion at a local part of the car body;
the second part module comprises: a module for building a boundary constraint of the car body, a module for defining a maximum vertical load and a compression load of the car body, a module for obtaining a composite load by linearly compositing, a module for defining a modal frequency of the car body, a module for defining a static load working condition, and a module for defining a linear buckling analysis working condition, which are configured by the human-machine interaction device, wherein:
the module for building a boundary constraint of the car body is configured to constrain and limit a degree of freedom of at least one position selected from the car body;
the module for defining a maximum vertical load and a compression load of the car body is configured to apply a uniformly distributed load, which is a maximum vertical load that the car body can bear, on a horizontal plane of the car body, and apply a longitudinal compression load on at least one position of the car body;
the module for obtaining a composite load by linearly compositing is configured to receive data from the module for defining the maximum vertical load and the compression load of the car body, and linearly composite the maximum vertical load and the compression load;
the module for defining a modal frequency of the car body is configured to set range values of the modal frequency of the car body as the standby, and provide the range values of the modal frequency of the car body to the third part module;
the module for defining a static load working condition is configured to set a static load of the car body as the standby; and
the module for defining a linear buckling analysis working condition is configured to connect the module for defining a static load working condition and the module for defining a modal frequency of the car body to obtain data of the static load and the modal frequency; and
the third part module is configured to perform a car body structure instability simulation analysis after obtaining the data of the first part module and the second part module, and the third part module comprises a module for calculating critical buckling coefficient, a module for extracting critical instability loading force, and a module for comparing and analyzing a car body structural strength loading force and a critical instability loading force, which are connected in sequence, wherein:
the module for calculating critical buckling coefficient is configured to output a critical buckling coefficient of the dent portion to the module for extracting critical instability loading force;
the module for extracting critical instability loading force is configured to obtain a maximum load allowed to be exerted on the structure at the dent portion, i.e., obtain a critical instability loading force in the case that the local structure of the car body loses stability, and output the critical instability loading force as the standby; and
the module for comparing and analyzing a car body structural strength loading force and a critical instability loading force is configured to obtain a critical instability loading force in the case that the a local part of the car body loses stability, extract the loading force of the local part after a car body structural strength analysis, and compare the critical instability loading force with the loading force of the local part, if the loading force obtained according to the car body structural strength is less than the critical instability loading force, the car body structure in this defect state is reliable during operating process, and if the loading force obtained according to the car body structural strength is greater than the critical instability loading force, a further reinforcing solution needs to be made to the car body structure having such defect to improve the rigidness of a defect part.

2. The finite element simulation device for car body local structure instability of a high-speed motor train unit according to claim 1, wherein the first part module comprises a module for setting material parameter of the car body, a module for setting plate thickness parameter of parts of the car body, a module for building a whole car body finite element model, and a module for building a local dent area model, wherein
the module for setting material parameter of the car body is configured to obtain parameters of material adopted by the car body;
the module for setting plate thickness parameter of parts of the car body is configured to obtain attribute assignments of plate thickness parameters of the parts of car body according to car body design drawing data;
the module for building a whole car body finite element model is configured to build a car body finite element model according to the car body structure shown in the drawings, wherein the car body structure is simulated by using a quadrilateral plate element, a local part is simulated by using a triangular plate element, and a two-dimensional model of the car body structure is obtained; and
the module for building a local dent area model is configured to build a dent model of the local part in the whole car body finite element model and set dimensions of a dent portion.

3. The finite element simulation device for car body local structure instability of a high-speed motor train unit according to claim 1, wherein the third part module further comprises a module for determining that the local part of the car body structure is reliable, a module for determining that the local part is required to be reinforced, and a module for comparing and analyzing a car body structural strength loading force and a critical instability loading force, and
according to a data analysis result, if the critical buckling coefficient is greater than or equal to 1, module for comparing and analyzing a car body structural strength loading force and a critical instability loading force is connected to the module for determining that the local part of the car body structure is reliable, and if the critical buckling coefficient is less than 1, module for comparing and analyzing a car body structural strength loading force and a critical instability loading force is connected to the module for determining that the local part is required to be reinforced.

4. The finite element simulation device for car body local structure instability of a high-speed motor train unit according to claim 3, wherein in the module for building a boundary constraint of the car body, translational degrees of freedom in three directions are constrained at four air springs of the car body.

5. The finite element simulation device for car body local structure instability of a high-speed motor train unit according to claim 1, wherein the compression load is set to be a car body longitudinal load exerted on a coupler mounting seat; and the maximum vertical load is set to be a uniformly-distributed load exerted on a car body floor.

6. The finite element simulation device for car body local structure instability of a high-speed motor train unit according to claim 5, wherein the maximum vertical load is 547.6 kN, i.e., the uniformly-distributed load exerted on the car body floor is 547.6 kN; the compression load is 1500 kN, i.e., the car body longitudinal load exerted on the coupler mounting seat is 1500 kN.

7. The finite element simulation device for car body local structure instability of a high-speed motor train unit according to claim 1, wherein in the module for building a whole car body finite element model, a size of a plate element is set to be 20 mm; and in the module for defining a modal frequency of the car body, a modal frequency is defined to range from 1 HZ to 40 HZ.

8. The finite element simulation device for car body local structure instability of a high-speed motor train unit according to claim 7, wherein in the module for building a local dent area model, the dent portion has a depth of 4 mm and a length of 3800 mm.

9. A finite element simulation method for car body local structure instability of a high-speed motor train unit, comprising following steps:
a first step, comprising performing modeling to designed shape and dimensions of the car body by a human-machine interaction device, and building a local dent model of the car body, to build and simulate at least one dent portion at a local part of the car body;
a second step, configuring boundary condition of the car body structure by the human-machine interaction device, wherein comprising steps in the following sequence:
S1, building a boundary constraint of the car body, comprising constraining and limiting a degree of freedom of at least one position selected from the car body;
S2, defining a maximum vertical load and a compression load of the car body, comprising: applying a uniformly-distributed load, which is the maximum vertical load exerted on the car body, on a horizontal plane of the car body, and applying a longitudinal compression load on at least one position of the car body;
S3, obtaining a composite load by linearly compositing, comprising linearly compositing the maximum vertical load and the compression load after data of the maximum vertical load and the compression load of the car body are set;
S4, defining a modal frequency of the car body, comprising setting range values of the modal frequency of the car body as the standby;
S5, defining a static load working condition, comprising setting a static load of the car body as the standby; and
S6, defining a linear buckling analysis working condition module, comprising configuring the static load and modal frequency data that are set; and
a third step, comprising:
performing a car body structural instability simulation analysis, obtaining a critical buckling coefficient 0.X of the dent portion by calculating, and confirming that an instability phenomenon occurs to the structure when a load reaches X % of the initially applied load according to results, and further obtaining the maximum load allowed to be exerted on the structure;
determining that the local part of the car body structure is reliable if the critical buckling coefficient is greater than or equal to 1; and
determining that the local part needs to be reinforced if the critical buckling coefficient is less than 1.

10. A finite element simulation method for car body local structure instability of a high-speed motor train unit, comprising following steps:
Step 1, inputting material parameters of a car body;
Step 2, performing an attribute assignment to plate thickness of parts of the car body according to car body design drawing data;
Step 3, building a car body finite element model according to the car body structure in drawings, wherein a car body structure is simulated by using a quadrilateral plate element and a local part is simulated by using a triangular plate element, to obtain a two-dimensional model of the car body;
Step 4, building a dent model of a local area in the whole car body finite element model, comprising setting a dent depth and a dent length of the dent area;
Step 5, configuring and building a boundary constraint condition of the car body, i.e. constraining translational degrees of freedom, at positions of four air springs, of the car body in three directions, and keeping the configuration in an activated state in subsequent constraint processes of the car body;
Step 6, setting a maximum vertical load and a compression load, and keeping respective cards in an activated state in subsequent load application process of the car body, applying a compression load in a longitudinal direction of the car body on a coupler mounting seat, and applying a uniformly-distributed load on a car body floor;
Step 7, performing calculation on complex working conditions, comprising linearly compositing two loads, i.e., the maximum vertical load and the compression load, to check the car body linear buckling under complex working conditions;
Step 8, defining a card of modal frequency of the car body, wherein a frequency range of the modal frequency is set to be from 1 HZ to 40 HZ.
Step 9, defining a static load working condition, comprising selecting the above boundary constraint condition and the composite load;
Step 10, defining a linear buckling analysis working condition, comprising selecting the static load working condition and the modal frequency of the car body which are defined above;
Step 11, calculating a critical buckling coefficient, comprising performing a car body structure instability simulation analysis to obtain the critical buckling coefficient 0.X of the dent portion by calculating;
Step 12, determining a maximum load allowed to be exerted on the structure if the result indicates that an instability phenomenon occurs to the structure when the load reaches X % of the initially applied load;
Step 13, comparing and analyzing the critical instability loading force when a dent portion occurs to the local area of the car body structure obtained in the above step and the loading force of the portion extracted after analyzing the strength of the car body structure;
Step 14, determining that the car body structure in the defect state is reliable during operating if the loading force obtained according to the car body structural strength is less than or equal to the critical instability loading force; and
Step 15, determining that further reinforcing solution needs to be made to the car body structure having the defect to improve the rigidness of the defect portion if the loading force obtained according to the car body structural strength is greater than the critical instability loading force.

11. The finite element simulation device for car body local structure instability of a high-speed motor train unit according to claim 2, wherein the third part module further comprises a module for determining that the local part of the car body structure is reliable, a module for determining that the local part is required to be reinforced, and a module for comparing and analyzing a car body structural strength loading force and a critical instability loading force, and
according to a data analysis result, if the critical buckling coefficient is greater than or equal to 1, module for comparing and analyzing a car body structural strength loading force and a critical instability loading force is connected to the module for determining that the local part of the car body structure is reliable, and if the critical buckling coefficient is less than 1, module for comparing and analyzing a car body structural strength loading force and a critical instability loading force is connected to the module for determining that the local part is required to be reinforced.

12. The finite element simulation device for car body local structure instability of a high-speed motor train unit according to claim 2, wherein the compression load is set to be a car body longitudinal load exerted on a coupler mounting seat; and the maximum vertical load is set to be a uniformly-distributed load exerted on a car body floor.

13. The finite element simulation device for car body local structure instability of a high-speed motor train unit according to claim 3, wherein the compression load is set to be a car body longitudinal load exerted on a coupler mounting seat; and the maximum vertical load is set to be a uniformly-distributed load exerted on a car body floor.

14. The finite element simulation device for car body local structure instability of a high-speed motor train unit according to claim 4, wherein the compression load is set to be a car body longitudinal load exerted on a coupler mounting seat; and the maximum vertical load is set to be a uniformly-distributed load exerted on a car body floor.

15. The finite element simulation device for car body local structure instability of a high-speed motor train unit according to claim 2, wherein in the module for building a whole car body finite element model, a size of a plate element is set to be 20 mm; and in the module for defining a modal frequency of the car body, a modal frequency is defined to range from 1 HZ to 40 HZ.

16. The finite element simulation device for car body local structure instability of a high-speed motor train unit according to claim 3, wherein in the module for building a whole car body finite element model, a size of a plate element is set to be 20 mm; and in the module for defining a modal frequency of the car body, a modal frequency is defined to range from 1 HZ to 40 HZ.

17. The finite element simulation device for car body local structure instability of a high-speed motor train unit according to claim 4, wherein in the module for building a whole car body finite element model, a size of a plate element is set to be 20 mm; and in the module for defining a modal frequency of the car body, a modal frequency is defined to range from 1 HZ to 40 HZ.

18. The finite element simulation device for car body local structure instability of a high-speed motor train unit according to claim 5, wherein in the module for building a whole car body finite element model, a size of a plate element is set to be 20 mm; and in the module for defining a modal frequency of the car body, a modal frequency is defined to range from 1 HZ to 40 HZ.

19. The finite element simulation device for car body local structure instability of a high-speed motor train unit according to claim 6, wherein in the module for building a whole car body finite element model, a size of a plate element is set to be 20 mm; and in the module for defining a modal frequency of the car body, a modal frequency is defined to range from 1 HZ to 40 HZ.
